(19) United States
(12) Patent Application Publication
(10) Pub. No.: US 2007/0097703 A1
(43) Pub. Date: May 3, 2007

(54) Integral solid-state luminaire with dual light paths and coaxial optics

(75) Inventor: Ervin Goldfain, Syracuse, NY (US)

Correspondence Address: HISCOCK & BARCLAY, LLP, 2000 HSBC PLAZA, 100 Chestnut Street, ROCHESTER, NY, 14604-2404, US

(73) Assignee: Welch Allyn, Inc.

(21) Appl. No.: 11/262,021

(22) Filed: Oct. 28, 2005

(51) Int. Cl. F21V 5/00; F21S 4/00

(52) U.S. Cl. 362/572; 362/800

(57) ABSTRACT

The invention includes a light and compact illuminator that can be powered from a portable and rechargeable battery. The illuminator includes two independent solid-state light sources and optics to converge the beams into a single high-intensity output beam. The components are enclosed in a lightweight, head-mounted housing.

### FIELD OF THE INVENTION

This invention relates to a surgical headlight with an integral light source.

### BACKGROUND OF THE INVENTION

Surgeons and other personnel who work in the medical field are often required to illuminate a portion of a patient during surgical procedures. The nature of the surgeon's duties during such procedures requires that they maintain a degree of free use of their hands. These requirements are generally satisfied by illumination assemblies known in the art as surgical headlights. Surgical headlights are mounted on the surgeon's head, and serve to illuminate the patient. The surgical headlight is an luminaire held on the surgeon's head with a headband, and having a high intensity light source. Generally, the high intensity light source is connected to the headband by a fiber-optic cable that serves to carry the light from the fiber optic light source to a luminaire.

LED technology is quickly emerging as a forerunner in solid-state illumination and one of the most promising candidates for replacing traditional and less versatile medical lighting techniques based on halogen, Xenon, metal halides, or low-power laser diodes. Solid-state illumination is small and lightweight compared to other technologies so the light source may be easily integrated into the luminaire body. The integrated light source eliminates the need to tether the luminaire to a remote light source with an optical cable. However, the challenge is to deliver a sufficiently intense beam of light along an axis that lies in the same plane with the user's viewing paths.

There exists a number of patents and published patent applications directed to integral solid-state luminaries including PCT International Publication Number WO 02/099332 A1 by Davis, et al., published Dec. 12, 2002. Davis teaches a lightweight headlight having a head piece with one or more light sources, preferably LED arrays, secured thereto. A light projector, such as a lens, reflector, or some combination thereof, is affixed to the head piece, and a fiber optic cable operably connects each light source to the light projector. Heat sinks, thermal insulation, and radiation reflectors may also be disposed between the arrays and the head piece. A power source housing may be affixed to the head piece, to the user, or to other clothing worn by the user.

PCT International Publication Number WO 03/083899 A2 by Kim, published Oct. 9, 2003 teaches a headlamp which includes multiple light sources and a camera. Each of the light sources includes an illumination part and a parabolic mirror. The multiple light sources provide increased luminous intensity on the work spot and the camera is mounted in the same direction of the light sources to enables the operator to photograph the desired spot. The electric power for the light sources can be cut off by detaching the electric junctions between the supporting rod and connecting part. The main body of the device is separately structured from the remote parts, to reduce the weight pressure on the operator's head. Kim does not teach the use of solid-state light sources or the use of coaxial optics. Therefore, what is needed is a headlight that uses solid-state light sources and coaxial optics to achieve a single, high-intensity and uniform illumination beam.

U.S. Patent Application Publication Number US 2005/0117327 A1 by Gupta, published Jun. 2, 2005 teaches a surgical headlight containing dual lamp housings, each containing one or more LED light sources. Both lamp housings may be adjusted so that light beams emitted by each may be selectively converged onto a spot located at a predetermined distance in front of the lamp housings. Each lamp housing typically contains, in addition to the LED(s), one or more reflectors to gather and direct light generated by the LED(s) forward to an illuminated work area. Batteries mounted either on the headband supporting the headlamp on a user's head or external to the headband, are used to power the LED(s). Switch and/or dimming circuitry may be provided. Hot swapping, a capability whereby batteries may be interchanged during a lengthy surgical procedure, is also provided. The headlamp taught by Gupta requires the user to adjust the separate lamps to converge on the work surface and does not teach coaxial optics. Therefore, what is needed is a headlight that uses solid-state light sources and coaxial optics to achieve a single, high-intensity and uniform illumination beam with minimal need for adjustment by the user.

### SUMMARY OF THE INVENTION

The invention comprises, in one form thereof, a light source unit and compact illuminator that can be powered from a portable and rechargeable battery. The illuminator includes two independent solid-state light sources and optics to converge the beams into a single high-intensity output beam. The components are enclosed in a lightweight, head-mounted housing.

More particularly, the invention includes a surgical headlight, comprising a plurality of solid state light sources, a plurality of coaxially aligned optical paths, and a portable battery pack in electrical communication with the light source to thereby power the unit. Each of the light sources comprise a white LED and one light source is laterally offset from another light source. The surgical headlight further includes a Fresnel condenser or a similar condenser lens proximate to each of the light sources. The invention even further includes a plurality of optical devices including a light concentrator for combining the light from the first and second light source, as well as collecting beams from any additional light sources, a prism mirror that directs the light to the light concentrator, a folding mirror, and a focusable projection lens having a meniscus lens and a positive lens. The battery pack is fixable to clothing or a headband and may comprise rechargeable batteries.

In an alternative embodiment, the surgical headlight, comprises a solid state light source, a plurality of coaxially aligned optical devices, an aperture wheel having a plurality of radially aligned apertures, and a portable battery pack in electrical communication with the light source. A portion of the apertures comprise filters and the remaining apertures have custom geometrical shapes, wherein the filters are selected from the group consisting essentially of polarizing filters, cobalt blue filters, red-free filters, and dichroic filters; and the shapes are selected from the group consisting essentially of a substantially circular shape, a half-moon shape, and a rectangular shape. The optical devices comprise a focusable projection lens, a Fresnel condenser lens between the light source and the negative lens, a folding mirror, and a projection lens between the aperture wheel and the folding mirror.

An advantage of the present invention is that the multiple solid-state light sources are projected through a lightweight and versatile coaxial optics system and therefore create an output illumination beam that behaves as though it was produced by a single source. The invention requires only minimal adjustment of the output beam such as to control the size of the illumination spot. Further, the invention provides a sufficiently intense and uniform beam without the need for a remote high-intensity light source thus lacking a fiber optic cable that adds weight to the headlight and restricts the user's freedom of motion. Even further, the invention provides an optional aperture wheel that gives the user flexibility in the special distortion, intensity, and shape of the projected spot.

### BRIEF DESCRIPTION OF THE DRAWINGS

The present invention is disclosed with reference to the accompanying drawings, wherein:

FIG. 1 is a isometric view of the surgical headlight of the present invention;

FIG. 2 is a schematic view of the luminaire according to the first embodiment of the invention; and

FIG. 3 is a schematic view of the luminaire according to the second embodiment of the invention.

Corresponding reference characters indicate corresponding parts throughout the several views. The examples set out herein illustrate several embodiments of the invention but should not be construed as limiting the scope of the invention in any manner.

### DETAILED DESCRIPTION

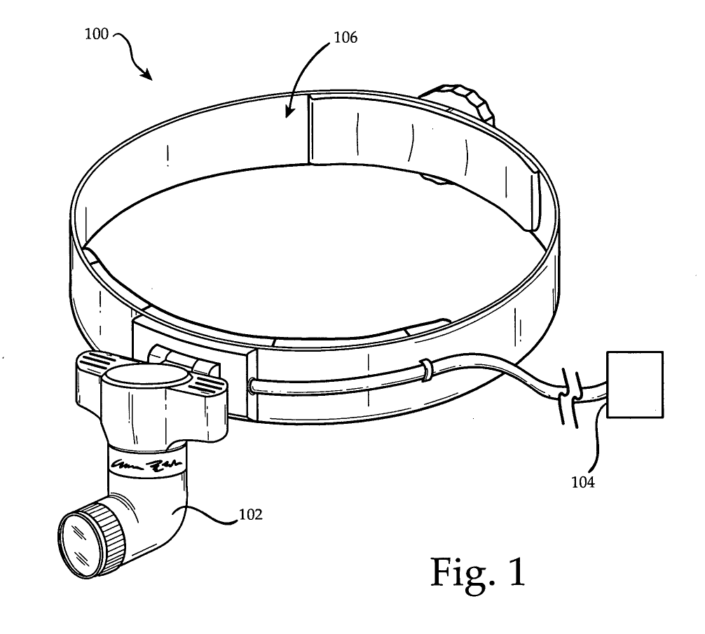

The luminaire of the present invention is shown in FIG. 1. The apparatus 100 includes a luminaire housing 102, a battery pack 104, and an headband 106. The headband 106 may take any of a number of forms that engage the user's head and provide a stable support for the luminaire housing 102.

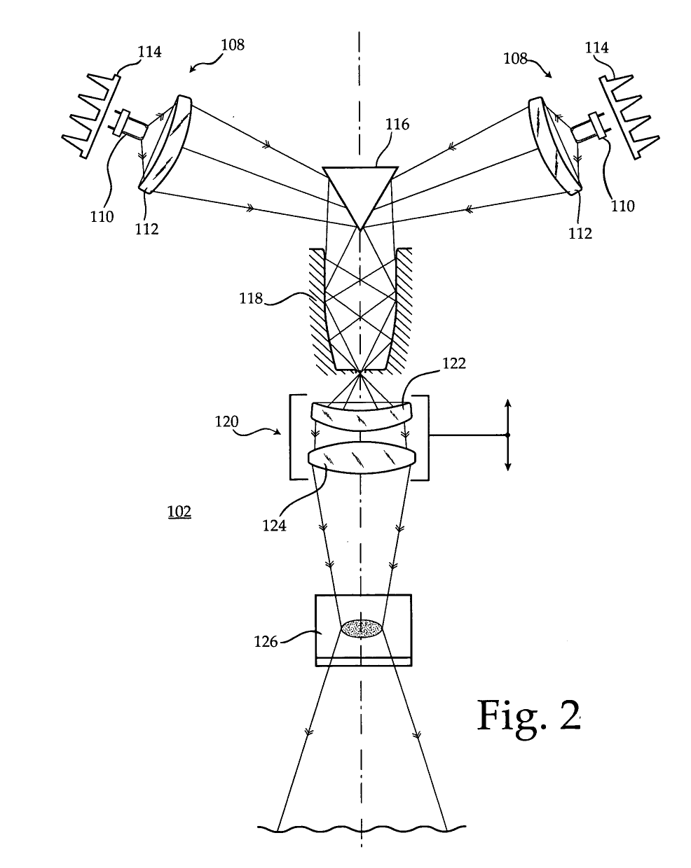

The luminaire housing 102 encloses the solid state light sources and the optics shown schematically in FIG. 2. A pair of opposing solid-state light sources 108 are provided on opposite sides of the housing 102 to distribute the weight of the housing 102 and allow improved heat dissipation. Each of the light sources 108 includes a white LED 110 such as a 5 watt LED sold under the trademark Luxeon, an aspheric condensing lens 112, and a distributed heat sink 114. The condensing lens 112 may be a Fresnel lens to reduce the size and weight of the lens. A light collimator such as those made by the Fraen Corporation may be used to direct the majority of the light from the LED 110 into the condensing lens 112. A fan may be provided proximate to the heat sink 114 to increase heat dissipation thus cooling the light sources 108.

The condensing lens 112 directs the light to a V-prism mirror 116 that reflects the light into a light concentrator 118, which may be a compound parabolic concentrator or an elliptical reflector. The output of the light concentrator 118 acts as a secondary light source having the combined intensity of the LEDs 110. The size of the illumination spot is varied by translating a set of projection optics 120 along the optical axis. The projection optics 120 include a meniscus lens 122 and a positive lens 124. The direction of the output beam is controlled by a folding mirror 126.

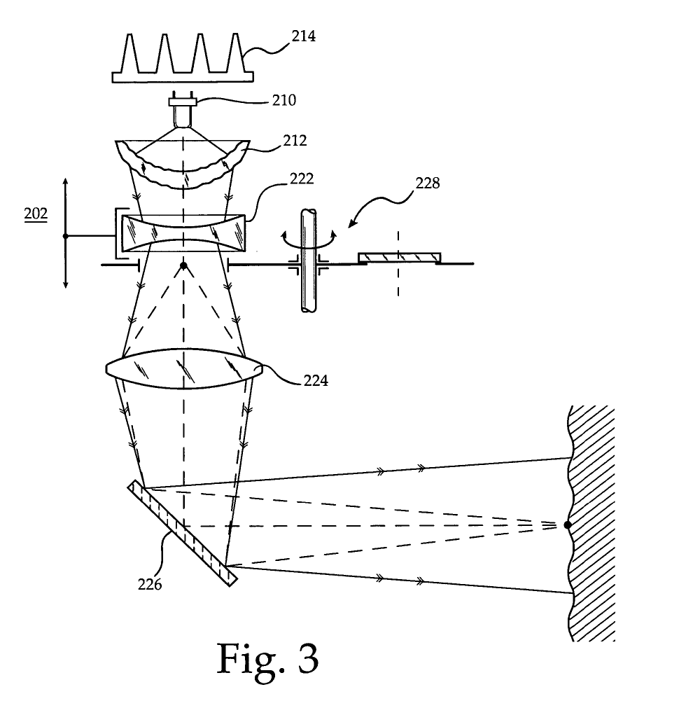

A second embodiment of the luminaire, shown schematically in FIG. 3, includes an aperture wheel having a plurality of selectable apertures for changing the projected spot. The luminaire housing 202 contains one or more solid-state light sources 208 having a distributed heat sink 214, a white LED 210, and a condensing lens 212. The condensing lens 212 is a domed or total internal reflection acrylic Fresnel lens with a high collection angle. A negative lens 222 translates along the optical axis to control the size of the illumination spot and directs the beam to an aspheric positive lens 224. The positive lens 224 directs the beam to a foldable mirror 226, which, in turn, directs the beam as required by the user.

An aperture wheel 228 is situated to place an aperture in the optical axis between the negative lens 222 and the positive lens 224. The aperture wheel 228 rotates about a central axis by a manual actuator such as a knob that is external to the luminaire housing 202 or by an electrical actuator driven by a small motor. The aperture wheel 228 is indexed into descrete positions that result in a particular aperture being substantially concentric with the optical axis. The apertures provided may include those having different shapes, such as a slit or a half-moon, or filters. The filters may include cobalt blue, red-free, dichroic, and specialized interference optical filters such as polarizers that provide glare reduction and subsurface visualization.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A surgical headlight, comprising:
a plurality of solid state light sources;
a plurality of coaxially aligned optical paths; and
a portable battery pack in electrical communication with the light source.

2. The surgical headlight of claim 1, wherein each of the light sources comprise a white LED.

3. The surgical headlight of claim 1, one light source being laterally offset from another light source.

4. The surgical headlight of claim 3, further comprising a Fresnel condenser lens proximate to each of the light sources.

5. The surgical headlight of claim 3, further comprising a plurality of optical devices including a light concentrator for combining the light from the first and second light source.

6. The surgical headlight of claim 5, wherein the optical devices include a prism mirror that directs the light to the light concentrator.

7. The surgical headlight of claim 1, further comprising a folding mirror and a focusable projection lens having a meniscus lens and a positive lens.

8. The surgical headlight of claim 1, wherein the battery pack is fixable to clothing.

9. The surgical headlight of claim 1, further comprising a headband, wherein the battery pack is attached to the headband.

10. The surgical headlight of claim 1, wherein the battery pack comprises rechargeable batteries.

12. A surgical headlight, comprising:
a solid state light source;
a plurality of coaxially aligned optical devices;
an aperture wheel having a plurality of radially aligned apertures; and
a portable battery pack in electrical communication with the light source.

13. The surgical headlight of claim 12, wherein a portion of the apertures comprise filters and the remaining apertures have shapes.

14. The surgical headlight of claim 13, the filters being selected from the group consisting essentially of polarizing filters, cobalt blue filters, red-free filters, and dichroic filters; and the shapes being selected from the group consisting essentially of a substantially circular shape, a half-moon shape, and a rectangular shape.

15. The surgical headlight of claim 12, the optical devices comprising a focusable projection lens.

16. The surgical headlight of claim 15, the optical devices further comprising
a Fresnel condenser lens between the light source and the negative lens;
a folding mirror; and
a projection lens between the aperture wheel and the folding mirror.
